(19) United States
(12) Patent Application Publication
(10) Pub. No.: US 2006/0095864 A1
(43) Pub. Date: May 4, 2006

(54) Method and system for representing an application characteristic using a sensory perceptible representation

(75) Inventors: Von A. Mock, Boynton Beach, FL (US); David J. Hayes, Lake Worth, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/980,999

(22) Filed: Nov. 4, 2004

(51) Int. Cl. G06F 17/00

(52) U.S. Cl. 715/810

(57) ABSTRACT

A portable electronic device (10) can include a user interface (12) enabling the representation of a characteristic of an application using a user perceptible representation of the application on a presentation device (14, 18 or 20) and a processor (15) coupled to the presentation device. The processor can be programmed to enable the selection (102) of a menu containing a representation of the application and non-textually vary (104) the user perceptible representation of the application based on a change in a characteristic of the application from an initial state of the application. The characteristic can be a frequency of use of the application or a power consumption measure of the application. Note, the portable electronic device can be any number of devices including, but not limited to a cellular phone, a camera phone, a video phone, a PDA, a two-way radio, a messaging device, or a laptop computer for example.

### FIELD OF THE INVENTION

This invention relates generally to user interfaces, and more particularly to a method and system for providing an indication of an application characteristic perceptible by a change in a representation of the application.

### BACKGROUND OF THE INVENTION

The complexity of user interfaces on small screen devices increases as the number of pre-installed and downloadable applications included in such devices increases. The user of small screen devices will generally optimize their menu structure (prune, remove or provide short cuts) and applications. In other words, seldom used or more frequently used applications will be reordered or deleted for more efficient menu navigation. Optimization usually involves the user manipulating the menu structure of the device by either removing infrequently or non-used menu items or applications, or reordering more frequently used application based on use, alphabetical order or other grouping. Unfortunately, most devices fail to provide users with ques (visual or otherwise) as to which applications have been used frequently, infrequently or not at all. Existing products also fail to provide knowledge of other application characteristics such as power consumption. With the advent of power hungry portable devices such as 2.5 G and 3 G cellular phones, a lack of tools and ques to effectively manage applications will only disappoint users of these next generation products.

### SUMMARY OF THE INVENTION

Embodiments in accordance with the present invention can provide users with user perceptible ques that indicate application characteristics useful in managing portable electronic products. Such ques can assist users for example in efficiently managing power consumption or efficiently structuring and navigating through complex menu structures by varying the user perceptible ques. The user perceptible ques can come in numerous forms including the form of varying icons, sizes of icons or text, color of icons or text, contrast of icons or text, spacing between icons or text, varying audio samples, length of audio samples, pitch or volume of audio samples, varying haptics, and varying haptic intensity just to name a few in order to represent application characteristics such as power consumption or frequency of use of applications.

In a first embodiment of the present invention, a method of representing a characteristic of an application using a user perceptible representation of the characteristic can include the steps of selecting a menu containing a representation of the application and non-textually varying the user perceptible representation of the application based on a change in a characteristic of the application from an initial state of the application. The step of non-textually varying the user perceptible representation can include the step of providing an audio representation representative of the characteristic by embedding a sound object associated with the characteristic. Not only can the sound object itself change (different sounds), but the audio representation can also vary in length, pitch or volume to represent the characteristic. The user perceptible representation can also be a visual representation representative of the characteristic that can be in the form of varying icons, icon or text size, color or contrast or spacing among icons or text in a menu list. Furthermore, the user perceptible representation can also include various haptics or varying the vibration intensity or duration of the haptic to represent the characteristic. The characteristics represented can include a frequency of use of an application, an infrequency of use of the application, a duration of use of an application, and a power consumption profile for the application. Again, the user perceptible representation can be almost any user distinguishable sensory representation including for example an audio clip associated with infrequent use, an audio clip associated with frequent use, a length of audio, a volume of audio, an icon associated with infrequent use, an icon associated with frequent use, an icon size or text size associated with infrequent use, an icon size or text size associated with frequent use, an icon color or text color associated with infrequent use, an icon color or text color associated with frequent use, an icon contrast or text contrast associated with infrequent use, an icon contrast or text contrast associated with frequent use, a relative spacing among items in a menu list associated with frequent or infrequent use, a vibration intensity, pattern or duration associated with frequent or infrequent use, and any of the above to represent a power consumption level for an application.

In a second embodiment of the present invention, a user interface enabling the representation of a characteristic of an application using a user perceptible representation of the application can include a presentation device and a processor coupled to the presentation device. The processor can be programmed to enable selection of a menu containing a representation of the application and non-textually vary the user perceptible representation of the application based on a change in a characteristic of the application from an initial state of the application. The processor can be programmed to non-textually vary the user perceptible representation by providing an audio representation representative of the characteristic for example by embedding a sound object associated with the application and the characteristic of the application. The audio representation itself can be changed or varied as well as the length, pitch or volume of the audio representation in order to represent the characteristic. Likewise, the user perceptible representation can be a visual representation that can change in content, size, color, contrast, and spacing among items in a menu. More specifically, these representations can vary in terms of an icon, an icon size, a text size, a icon color, a text color, an icon contrast, a text contrast, a spacing among icons or text in a menu list. The user perceptible representation can also be a vibration that can vary in terms of intensity, pattern, or duration to represent the characteristic.

In a third embodiment of the present invention, a portable electronic device can include a user interface enabling the representation of a characteristic of an application using a user perceptible representation of the application on a presentation device and a processor coupled to the presentation device. The processor can be programmed to enable the selection of a menu containing a representation of the application and non-textually vary the user perceptible representation of the application based on a change in a characteristic of the application from an initial state of the application, wherein the characteristic is among a frequency of use of the application and a power consumption measure of the application. Note, the portable electronic device can be any number of devices including, but not limited to a cellular phone, a smart phone, a camera phone, a video phone, a GPS receiver, a PDA, a two-way radio, a messaging device, a satellite phone, an MP3 player, a portable DVD player, a portable television, a portable household appliance, a portable personal hygiene device, a laptop computer, a remote control, a game controller, a gaming device, or any combination thereof.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a portable electronic product using a system for representing an application characteristic using a user perceptible representation in accordance with an embodiment of the present invention.

FIG. 2 is a user interface having the user perceptible representations in accordance with an embodiment of the present invention.

FIG. 3 is the user interface of FIG. 2 having several of the user perceptible representations varying in accordance with an embodiment of the present invention.

FIG. 4 is a user interface including a list of menu items using spacing among items in accordance with an embodiment of the present invention.

FIG. 5 is a user interface including a list of menu items and using haptics in accordance with an embodiment of the present invention.

FIG. 6 is a flow chart illustrating a method of representing an application characteristic in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

User perceptible ques that indicate application characteristics can be useful for users in managing portable electronic products. Such ques can assist users in numerous functions including, but not limited to power management, menu structuring, and menu navigation. The user perceptible ques can come in numerous forms that are detected by some or all the senses. Most examples disclosed herein involve visual, audio, or the sense of touch, but embodiments contemplated within the scope of the invention can equally include the sense of smell and taste associated with an application characteristic. Some of the examples of user perceptible ques can come in the form of varying icons, sizes of icons or text, color of icons or text, contrast of icons or text, spacing between icons or text, varying audio samples, length of audio samples, pitch or volume of audio samples, varying haptics, and varying haptic patterns or intensity just to name a few in order to represent application characteristics such as power consumption or frequency of use of applications. Furthermore, other application characteristics can be represented besides frequency of use or power consumption. Other characteristics that can be represented can include, but are not necessarily limited to latency of an application, memory allocation, security, digital rights management, virus protection, or compatibility with an operating system or another application.

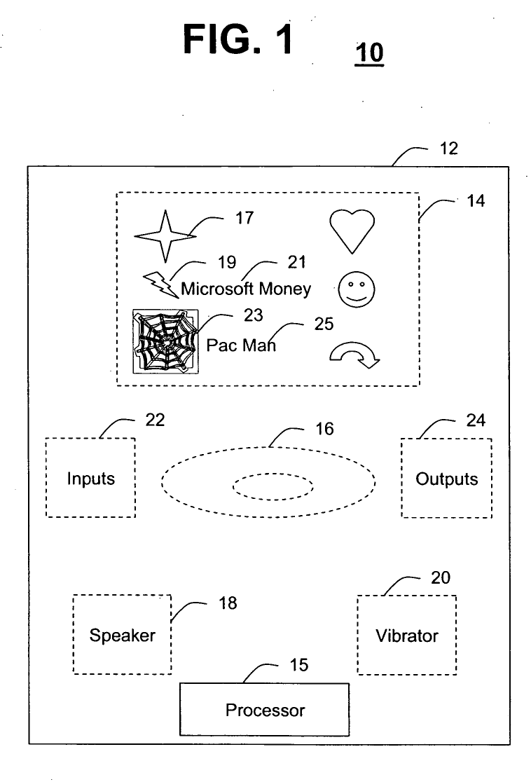

Referring to FIG. 1, a portable electronic product 10 (such as a cellular phone, a smart phone, a camera phone, a video phone, a GPS receiver, a PDA, a two-way radio, a messaging device, a satellite phone, an MP3 player, a portable DVD player, a portable television, a portable household appliance, a portable personal hygiene device, a laptop computer, a remote control, a game controller, a gaming device, and any combination thereof) can include a user interface 12 enabling the representation of a characteristic of an application using a user perceptible representation of the characteristic can include a presentation device and a processor 15 coupled to the presentation device. The presentation device can include any number of devices such as a display 14, a speaker 18 or vibrator 20. The presentation device can also include any number of output devices 24 depending on the type of portable electronic product being used. Likewise, the portable electronic product 10 can include any number of input devices 22 (e.g., microphones, joysticks, keyboards, keypads, etc.). For example, a cellular phone or most communication or computing devices may further include a navigation tool 16 such as a navigation key or keys or a touchpad.

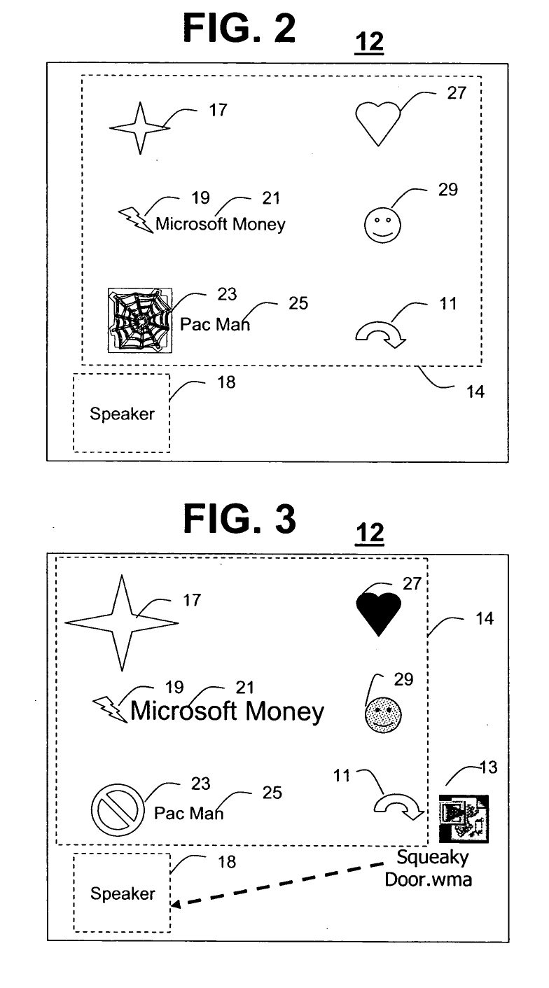

The processor 15 can be programmed to enable selection of a menu containing a representation of the application and non-textually vary the user perceptible representation of the application based on a change in a characteristic of the application from an initial state of the application. Examples of how the user perceptible representation can be changed to represent an application characteristic are illustrated in FIGS. 2-5. The processor can be programmed to non-textually vary the user perceptible representation by providing an audio representation representative of the characteristic for example by embedding a sound object associated with the application and the characteristic of the application. The audio representation itself can be changed or varied as well as the length, pitch or volume of the audio representation in order to represent the characteristic. For example, to represent an application or menu item 11 that is infrequently used, an embedded object 13 can be tagged or associated with the infrequently used application or menu item as shown in FIGS. 2 and 3. As a user goes to use the infrequently used application or menu item, the user will hear a squeaky door sound provided by the “Squeaky Door.wma” embedded object (13) via speaker 18. As illustrated in FIG. 3, the object 13 would not necessarily be visible in the display 14, but can certainly be heard through the speaker 18 of the user interface 12. Likewise, if an application is frequently used, the user can optionally hear something to indicate frequent use of the application such as a lightning bolt sound, cars racing, or a gun shot. As noted above, varying degrees of sound clips in terms of duration or volume can also be used to distinguish between levels of use or between other characteristics.

Likewise, the user perceptible representation can be a visual representation that can change in content, size, color, contrast, and spacing among items in a menu. More specifically, as shown in FIGS. 2 and 3, these representations can vary in terms of an icon (see icon 23), an icon size (see icon 17), a text or font size (see text 21), an icon color (see icon 27), a text color, an icon contrast (see icon 29), and a text contrast. In specific examples, an icon 19 or text 21 representing an application (Microsoft Money) or an icon 23 tagged to an icon or text 25 representing an application (such as Pac Man) can indicate a usage frequency or some other characteristic. For example, the spider web icon 23 can indicate infrequent usage whereas the lightning bolt icon 19 can indicate frequent usage. The color or contrast of another application represented by icon 27 can also provide other indications. A dark color or the color blue usually indicates cold or giving the feeling of being distant and could be used as representing infrequent use as shown in FIG. 2. While a frequently used application might use another color as shown in FIG. 3. Depending on the display capabilities (color, contrast gradients, etc.) varying degrees of color spectrum or contrast can be used to indicate how frequently a menu tree is traversed or an application is used. An icon or text with less contrast can provide an indication of infrequent use. The font size as shown with text 21 can be varied relative to other text to give a feeling that the application is shrinking into non-existence due to infrequent use or alternatively can provide an indication of power consumption. Furthermore, if text, font or icon size is used as a feature to indicate frequency of use, a further function can remove the application or menu item from the screen once it has reached (or fallen below) a threshold level. The user can “reinstall” or re-activate the menu or application item by retrieving it from the “infrequent used applications bin”, for example. Note, although the representations are “non-textually” varied herein, this does not mean that the text itself cannot be varied in terms of size, color or contrast as contemplated in the claims appended hereto. Non-textually is intended to exclude a change from one text to another text in terms of content (e.g., from “frequent” to “infrequent”) and also exclude the removal of text from a menu or itemized list. Further note that “application” and “menu item” are used interchangeably and should be interpreted similarly.

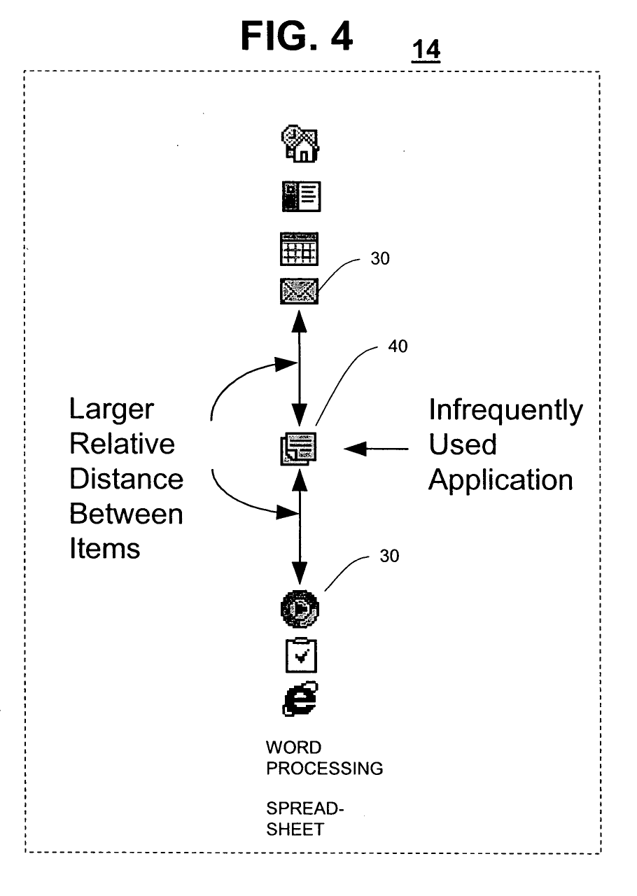

Spacing between menu items can also provide an indication of an application characteristic as illustrated in FIG. 4. Item 40 is spaced farther away from remaining items 30. The items can be icons or text in a menu list. The relative distance between one text or icon and an adjacent text or icon being larger than more frequently used applications or menu items can give the feeling of “not wanted” or “not part of the more popular group” as illustrated in FIG. 4.

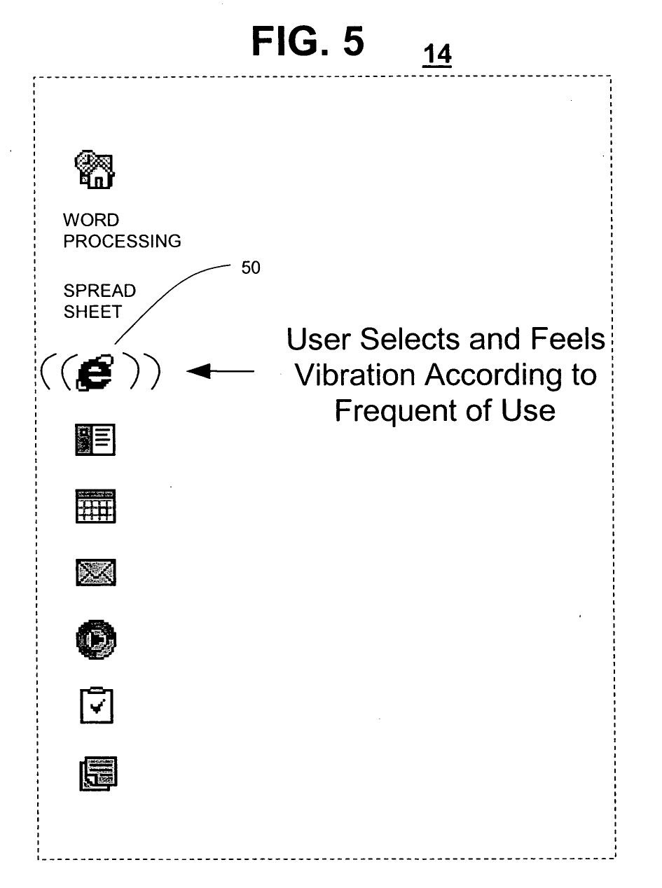

The user perceptible representation can also be a vibration or haptic that can vary in terms of intensity, pattern, or duration to represent the characteristic. For representing infrequent use, a particular embodiment using haptics can use the human knowledge or association of the earth relieving internal pressure in earthquakes or volcanoes to represent such infrequent usage. The longer between the release of pressure in earthquakes or volcanoes usually creates a more catastrophic event. Borrowing from this natural phenomenon, a menu item or application 50 as shown in FIG. 5 can vibrate as it is selected and vary in intensity or duration to indicate the frequency of use or the amount of time since the last use using the vibrator 20. Menu items rarely traversed or applications rarely used can receive a high intensity and/or long duration vibration while menu items or applications frequently used can receive no vibration or a low intensity and/or low duration vibration.

Measuring the frequency of use can be measured utilizing the duration of time between application use and/or the total amount of time used. Each application can have dynamic attributes indicating the time since the last use as well as the total duration of use to facilitate such feature. For menu items, a menu item can have the time since the last navigation path traversed such menu item and/or the number of times traversed.

As mentioned above, embodiments of the present invention are not limited to just one characteristic, but can include use of many others such as the power consumption of an application. For example, an application icon can be larger relative to the another application icons based on the amount of power consumed. Compare icon 17 with icons 21 or 23 in FIG. 3. Icon 17 can represent a power hungry application such as a camera function and icon 19 can represent a less power consuming application such as a spreadsheet application. Note, a product designer in accordance with an embodiment of the present invention can use multiple variations in representations to represent different characteristics. For example, an application icon or text can appear larger to represent greater power consumption while also being able to change colors or tagged with another icon to represent a certain usage frequency.

How power or frequency of use is determined for a particular application can vary. In one instance, an application icon can appear larger than others based on the amount of power consumed during a measurement period, e.g. the previous battery discharge cycle. Here, the icon of an application used less frequently can actually appear larger due to the amount of total power consumed during a given measurement period. In another case, an application icon can appear larger than others based on the power consumed by the application when it is actually running in real time (not the amount of capacity consumed over time). Therefore, an application like playing MP3s or full motion video would appear larger than a pocket Microsoft Word application, although the pocket Word application is likely used more often and consumes more battery capacity for example. In another embodiment, a power consumption meter status icon that gives (nearly instantaneous) power consumption status so that the user can make their own correlation between increased power consumption and the application (or applications) that are running (e.g. “When I play a video, the current meter pegs”). In yet another embodiment, an application can have a histogram of applications and user controllable features (including backlight, vibrate and other miscellaneous functions) showing how much of the device's battery was drained by a particular application. This histogram can be an extension of the Windows process-monitoring step to average the percentage of processing power for radio usage or other usage (application process, DSP plus analog components) over hours, days, weeks, or battery charge for example. The application can be configured to use the traditional Windows process task manager, but also include a column for battery power usage (CPU %, CPU Time, Memory Usage, Battery Power Usage).

Measuring the power consumption and adjusting an icon's size for example can be based on information on the power consumption of an application during use, e.g. the icon size of the 600 milliwatt MP3 player would be larger than the 200 milliwatt pocket word application. Alternatively, the icon size can be based on the power consumption during a unit of time or capacity, e.g. the MP3 player consumed ¼ of the battery capacity last time and is larger than the pocket word application that consumed 1/16 of the battery capacity last time. In another alternative, the icon size can be based over a period of time where the MP3 player consumed 4 watts of power out of 10 watts available in a week time period.

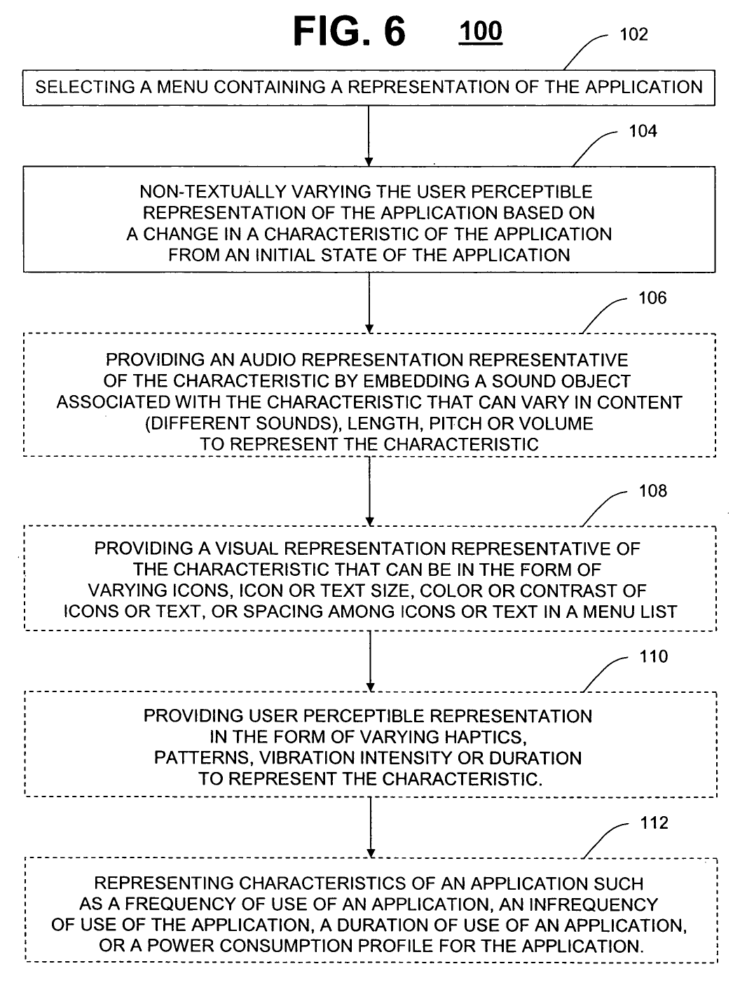

Referring to FIG. 6, a method 100 of representing a characteristic of an application using a user perceptible representation of the characteristic can include the step 102 of selecting a menu containing a representation of the application and the step 104 of non-textually varying the user perceptible representation of the application based on a change in a characteristic of the application from an initial state of the application. The step of non-textually varying the user perceptible representation can include the step 106 of providing an audio representation representative of the characteristic by embedding a sound object associated with the characteristic. Not only can the sound object itself change (different sounds), but the audio representation can also vary in length, pitch or volume to represent the characteristic. The user perceptible representation can alternatively or optionally be a visual representation representative of the characteristic that can be in the form of varying icons, icon or text size, color or contrast or spacing among icons or text in a menu list as noted at step 108. Furthermore, the user perceptible representation as noted at alternative or optional step 110 can also include various haptics or varying the vibration intensity or duration of the haptic to represent the characteristic. The characteristics represented at step 112 can include a frequency of use of an application, an infrequency of use of the application, a duration of use of an application, and a power consumption profile for the application. Again, the user perceptible representation can be almost any user distinguishable sensory representation including for example an audio clip associated with infrequent use, an audio clip associated with frequent use, a length of audio, a volume of audio, an icon associated with infrequent use, an icon associated with frequent use, an icon size or text size associated with infrequent use, an icon size or text size associated with frequent use, an icon color or text color associated with infrequent use, an icon color or text color associated with frequent use, an icon contrast or text contrast associated with infrequent use, an icon contrast or text contrast associated with frequent use, a relative spacing among items in a menu list associated with frequent or infrequent use, a vibration intensity, pattern or duration associated with frequent or infrequent use, and any of the above to represent a power consumption level for an application.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of representing a characteristic of an application using a user perceptible representation of the characteristic, comprising the steps of:
selecting a menu containing a representation of the application; and
non-textually varying the user perceptible representation of the application based on a change in a characteristic of the application from an initial state of the application.

2. The method of claim 1, wherein the step of non-textually varying the user perceptible representation comprises the step of providing an audio representation representative of the characteristic.

3. The method of claim 2, wherein the step of providing an audio representation comprises embedding or tagging a sound object associated with the characteristic.

4. The method of claim 2, wherein the step of providing an audio representation comprises varying at least one among the length, pitch or volume of the audio representation to represent the characteristic.

5. The method of claim 1, wherein the step of non-textually varying the user perceptible representation comprises the step of providing a visual representation representative of the characteristic.

6. The method of claim 5, wherein the step of providing the visual representation comprising the step of varying at least one among an icon, an icon size, a text size, a icon color, a text color, an icon contrast, a text contrast, and a spacing among icons or text in a menu list.

7. The method of claim 1, wherein the step of non-textually varying the user perceptible representation comprises the step of providing a varying vibration intensity, pattern or duration representative of the characteristic.

8. The method of claim 1, wherein the characteristic is selected from the group comprising a frequency of use of an application, an infrequency of use of the application, a duration of use of an application, and a power consumption profile for the application.

9. The method of claim 8, wherein the step of non-textually varying the user perceptible representation comprises using at least one among an audio clip associated with infrequent use, an audio clip associated with frequent use, a length of audio, a volume of audio, an icon associated with infrequent use, an icon associated with frequent use, an icon size or text size associated with infrequent use, an icon size or text size associated with frequent use, an icon color or text color associated with infrequent use, an icon color or text color associated with frequent use, an icon contrast or text contrast associated with infrequent use, an icon contrast or text contrast associated with frequent use, a relative spacing among items in a menu list associated with frequent or infrequent use, a vibration intensity or duration associated with frequent or infrequent use, and any of the above to represent a power consumption level for an application.

10. A user interface enabling the representation of a characteristic of an application using a user perceptible representation of the application, comprising:
a presentation device; and
a processor coupled to the presentation device, wherein the processor is programmed to:
enable selection of a menu containing a representation of the application; and
non-textually vary the user perceptible representation of the application based on a change in a characteristic of the application from an initial state of the application.

11. The user interface of claim 10, wherein the processor is programmed to non-textually vary the user perceptible representation by providing an audio representation representative of the characteristic.

12. The user interface of claim 11, wherein the processor is programmed to provide an audio representation by embedding a sound object associated with the application and the characteristic of the application.

13. The user interface of claim 11, wherein the processor is programmed to provide an audio representation by varying at least one among the length, pitch or volume of the audio representation to represent the characteristic.

14. The user interface of claim 10, wherein the processor is programmed to non-textually vary the user perceptible representation by providing a visual representation representative of the characteristic.

15. The user interface of claim 14, wherein the processor is programmed to provide the visual representation by varying at least one among an icon, an icon size, a text size, a icon color, a text color, an icon contrast, a text contrast, a spacing among icons in a menu list of icons.

16. The user interface of claim 10, wherein the processor is programmed to non-textually vary the user perceptible representation by providing a varying vibration intensity, pattern or duration representative of the characteristic.

17. The user interface of claim 10, wherein the the characteristic is selected from the group comprising a frequency of use of an application, an infrequency of use of the application, a duration of use of an application, and a power consumption profile for the application.

18. The user interface of claim 17, wherein the processor is programmed to non-textually vary the user perceptible representation by using at least one among an audio clip associated with infrequent use, an audio clip associated with frequent use, a length of audio, a volume of audio, an icon associated with infrequent use, an icon associated with frequent use, an icon size or text size associated with infrequent use, an icon size or text size associated with frequent use, an icon color or text color associated with infrequent use, an icon color or text color associated with frequent use, an icon contrast or text contrast associated with infrequent use, an icon contrast or text contrast associated with frequent use, a relative spacing among items in a menu list associated with frequent or infrequent use, a vibration intensity or duration associated with frequent or infrequent use, and any of the above to represent a power consumption level for an application.

19. A portable electronic device, comprising:
a user interface enabling the representation of a characteristic of an application using a user perceptible representation of the application on a presentation device; and
a processor coupled to the presentation device, wherein the processor is programmed to:
enable selection of a menu containing a representation of the application; and
non-textually vary the user perceptible representation of the application based on a change in a characteristic of the application from an initial state of the application, wherein the characteristic is among a frequency of use of the application and a power consumption measure of the application.

20. The portable electronic device of claim 19, wherein the portable electronic device comprises at least one among a cellular phone, a smart phone, a camera phone, a video phone, a GPS receiver, a PDA, a two-way radio, a messaging device, a satellite phone, an MP3 player, a portable DVD player, a portable television, a portable household appliance, a portable personal hygiene device, a laptop computer, a remote control, a game controller, a gaming device, and any combination thereof.
